(19) United States
(12) Patent Application Publication
(10) Pub. No.: US 2019/0322126 A1
(43) Pub. Date: Oct. 24, 2019

(54) ARTWORK SUBSTRATES HAVING RAISED OUTER EDGES TO PREVENT CURABLE COATINGS FROM SPILLING OVER OUTER PERIMETERS THEREOF

(71) Applicant: Foremost Manufacturing Co., Inc., Union, NJ (US)

(72) Inventor: Elizabeth Schiller, Richmond, VA (US)

(21) Appl. No.: 16/167,085

(22) Filed: Oct. 22, 2018

Related U.S. Application Data
(60) Provisional application No. 62/660,214, filed on Apr. 19, 2018.

(51) Int. Cl. B44D 3/22; B44D 3/18; B44D 2/00

(52) U.S. Cl. CPC B44D 3/22; B44D 2/00; B44D 3/18

(57) ABSTRACT

An artwork system includes a metal substrate having a top surface, a bottom surface, and an outer perimeter. The top surface of the metal substrate is anodized. The outer perimeter of the metal substrate includes a curved outer edge that projects above the top surface of the metal substrate to define a raised rim that extends around the outer perimeter of the metal substrate. The top surface of the metal substrate is covered with artwork such as a painting. A curable, transparent, coating overlies the artwork and the top surface of the metal substrate. The curable transparent coating has an outer perimeter that abuts against the curved outer edge of the metal substrate. The curved outer edge of the substrate has an inner concave surface that faces toward a center of the metal substrate and an outer convex surface that faces away from the center of the metal substrate. The curable, transparent coating has an outer perimeter that abuts against the inner concave surface of the curved outer edge of the metal substrate

### CROSS-REFERENCE TO RELATED APPLICATIONS

The present patent application claims benefit of U.S. Provisional Application Ser. No. 62/660,214, filed Apr. 19, 2018, the disclosure of which is hereby incorporated by reference herein.

### BACKGROUND OF THE INVENTION

### Field of the Invention

The present patent application is generally related to the art industry, and is more particularly related to substrates used for making artworks.

### Description of the Related Art

Before being hung on walls or displayed on tables, artistic works such as photographs are typically placed within frames. For many photographers and artists, however, it is frustrating to spend so much time and effort to produce a captivating photograph only to later draw attention away from the photograph by placing a frame around its perimeter. In response to this situation, many photographers and artists have begun to use curable, epoxy resins that are poured over photographs and then cured to provide thick, glossy topcoats that enhance the appearance of the photographs. Other artists have begun to apply the curable, epoxy resins to pictures that are painted on metal substrates.

Artists and photographers have confronted many problems when using existing curable, epoxy resin products. In the past, curable, epoxy resins were produced solely as industrial adhesives. Although the industrial resins provided artwork and photographs with a sleek, glossy look, and artists were generally pleases with the aesthetic effects, the industrial resins are hard to source, and produce toxic fumes that cause headaches. In addition, the cured resins tend to turn yellow over time, which discolors the underlying artwork and/or photographs.

Thus, there is a continuing need for improved curable materials that are placed over photographs and artwork that are safe, easy to use, and maintain clarity. There is also a need for improved substrates that receive the artwork and cured materials. Moreover, there is a continuing need for an improved artwork substrate that prevents the uncured resin material from spilling and/or flowing over the outer edges of the substrate and that prevents the formation of unwanted residue, beads, and/or nubs on the edges, sides or undersides of artwork substrate.

### SUMMARY OF THE INVENTION

In response to the above-noted problems with pre-existing curable materials (e.g., curable resin products), ArtResin Inc. located on Waterdown, Ontario, Canada, has developed a curable resin that satisfies the needs of artists, that remains crystal clear, that does not yellow, that is safe and easy to use, and that does not have the performance limitations found in industrial resins.

Working with a chemist located in Texas, ArtResin Inc. developed a curable, epoxy resin that has two equal parts, a resin and a hardener, that are mixed together prior to being poured and spread over a photograph, artwork, etc. The new curable resin formula (“the ArtResin product”) does not require the use of a respirator in order to apply it to a surface. The ArtResin product is part of a “clean system” that has no solvents or non-reactive diluents. Everything in the ArtResin product reacts, so that there are no volatile organic compounds (VOCs) released into the air, and no chemicals that can irritate the lungs or skin. Many prior art, curable resins have a very powerful odor, but the ArtResin product has virtually no odor.

Similar to pre-existing, curable resin products on the market, the ArtResin product contains a UV stabilizer to protect against the damaging (i.e., yellowing) effects of UV light. In one embodiment, the ArtResin product contain something new, an additional additive, referred to as a hindered amine light stabilization (HALS) additive, which minimizes yellowing of the cured resin coating and the underlying art or photograph. The HALS additive works by inhibiting UV light-induced reactions that lead to degradation. The new ArtResin product has a unique chemistry that does not discolor works as other resins do. In one embodiment, the ArtResin product provides a clear, thick, glossy, rock hard, durable finish that transforms prints into a product of professional photography, and enhances the appearance of artwork.

The ArtResin product is purchased by photographers and artists from around the world. Unlike pre-existing resins, the ArtResin product can be easily shipped overseas because its chemical formula has no VOCs so that it is not classified as a hazardous material (HAZMAT).

The ArtResin Inc. website, wymartresin.corn, provides a wealth of information including how-to videos, a Frequently Asked Questions (FAQ) section, and a resin calculator tool to help users determine how much resin needs to be applied to a surface of a photograph or artwork.

In one embodiment, the following steps may be taken to apply the ArtResin product to an artwork. The steps may include measuring, mixing, pouring, and waiting.

Measuring. In one embodiment, wearing gloves, a user pours equal amounts of a resin solution and a hardener solution into a mixing cup. The User may refer to a resin coverage calculator at www.artresin.com to determine how much resin and hardener will be needed. In one embodiment, a 32 oz Starter Kit of the ArtResin product covers an eight square foot surface, a one gallon Studio Kit of the ArtResin product covers a 32 square foot surface, and a two gallon Professional Kit of the ArtResin product covers a 64 square foot surface.

Mixing. The resin and hardener solution is well stirred for at least three (3) minutes. During mixing, the sides and the bottom of the mixing cup should be scrapped to make sure the mixing is thorough (unmixed material will result in sticky spots being present in the poured resin layer that will not fully cure). Once the resin and the hardener are completely mixed together, a user has about 45 minutes of working time before the resin thickens and cures.

Pouring. After making sure that the artwork to be covered is level, the mixed ArtResin product is poured over the work. The uncured resin will start to level on its own, and a user may spread the resin around the surface and into place. If the resin runs over the outer edges of the artwork, a brush may be used to clean up the edges. Bubbles will begin to rise to the surface of the uncured resin layer. Many of the bubbles will pop on their own, but the bubbles can also be popped using an Artist's Torch or by blowing on the exposed surface of the uncured resin layer.

Waiting. After being applied over a surface of a substrate, an artwork, or a photograph, the ArtResin product needs to cure for several hours in a dust-free environment. About eight hours after being applied, the resin layer will be tacky, however, a user may pour a second coat of the ArtResin product, if necessary or desired. After about 12 hours, the resin coating will be dry to the touch, and within 24 hours, the resin coating will be 95% cured. The ArtResin product will preferably be fully cured within about 72 hours.

Resin coatings tend to “spill” over the outer edges of artworks, frames, and photographs, which results in the formation of undesirable hardened nubs that must be removed.

The ArtResin Inc. website, www.artresin.com, teaches five different techniques for avoiding and/or removing cured, resin nubs along the edges or undersides of artworks that have been coated with the ArtResin product or curable resins.

Technique #1: Let the resin run over the edges, down the sides, and rub it in. This is probably the easiest technique. When uncured, simply let the ArtResin product run over the outermost edges of the work piece and down the sides, and then rub it in and smooth it out with a gloved hand. Before applying any resin, however, it is a good idea to tape off the underside of the piece so that the drips of the resin that collect on the bottom will pull right off with the tape. When pouring the ArtResin product onto an artwork, users should insure that the artwork is spaced from an underlying supporting surface (e.g., a table) so that the work is not glued to the underlying supporting surface.

Technique #1 yields an unpolished, finished look, which some individuals may like and some (i.e., perfectionists) may not. To provide a more polished look, a user could try smoothing the ArtResin product repeatedly after 15 minute intervals, and quickly running a torch over the sides to thin and smooth out the ArtResin product Finally, the tape on the underside of the artwork may be removed within 24 hours for the least amount of headache.

Technique #2: Create a dam with tape. When ArtResin Inc. first started to apply resin coatings to artwork, it masked off the edges with rugged, wide tape, leaving a ridge above so that it created a low barrier in which the wet resin pooled. This technique worked very well, especially if using duct tape a few times around, folded over on itself so that the non-sticky side also faces in where the ridge is. One artist who routinely employs this technique, Josie Lewis, suggests using metal venting tape that can be found in any hardware store. It is more expensive but the results justify the cost.

Four to six hours after pouring the ArtResin product onto an artwork, the tape dam may be removed. Timing is critical because the four to six hour time period is when the resin has set up, but the resin material is still flexible enough so a user can remove the tape with minimal issues. A user could remove the tape the next day, but it will require a bit more elbow grease.

Once the tape is pulled off, a user may notice that the resin has formed a meniscus (i.e., an area where the resin curves up a bit around the perimeter due to surface tension).

With a proper tool, like a router table and bits, a user can cut the top edges at a 45 degree angle to provide a professional looking finish. In the absence of a router table, a razor knife having a sharp blade may be used. The blade may be run along the meniscus before the resin has cured for 24 hours old (i.e., when the resin it is still sufficiently soft so that a knife can easily pass through the resin material).

Technique #3: Trimming the outer edges of the artwork with a table saw. This technique may be one of the most professional methods for finishing edges, however, it requires using a table saw. In one embodiment, a user may start by taping the edges. Once the resin is cured, a user can machine it, meaning the user can cut it and drill it with power tools without concern. The table saw is set up and the guide is locked into place so the artwork will run smoothly along the table saw at the perfect spot. In one embodiment, a user will preferably trim off a blade's width around the perimeter of the artwork, sawing through the combination of the resin, the artwork, and the wooden support. The resin will preferably cut cleanly at 90 degrees to reveal an aesthetically pleasing cross-section of the resin. The wood will show as the finished edge, or the cut edges may be painted, if desired.

Technique #4: Sand irregular cured resin (e.g., nubs) and then paint. This technique is fairly self-explanatory. Cover the artwork with the resin coating and allow it to flow over the edges. Once the resin coating has cured for at least 24 hours, use sand paper, a sanding block, a file, and/or a power palm/hand sander to make the outer edges and underside of the artwork perfectly smooth. After removing the cured, hardened nubs, the sanded/field edges may be painted.

Technique #5: Dome the resin product, avoiding the sides all together. Unlike many epoxy resins, the ArtResin product domes up beautifully at the edge of the work so that it forms a soft curve between the surface of the artwork up to the natural level height of the resin. Doming is easy to achieve, it just takes a bit of patience. By pouring the ArtResin product in the center of the work and working slowly outward, the resin is viscous enough to only go where the user guides it. As a result, a user may guide it out to the very edge of the artwork without going over the edge. The edge may then be painted a desired color. Technique #5 looks very professional, however, ArtResin Inc. teaches that it may only be used on wooden panels where the edges form a sharp 90 degree corner.

Referring to FIG. 1, a curable resin product 20, such as the ArtResin product disclosed at www.artresin.corn, is poured over the surface of an artwork 22.

Referring to FIGS. 2 and 3, the curable resin product 20 spills over the outer edges 24 of the artwork 22.

Referring to FIG. 4, the spilled resin may form beads or nubs 26 over a surface of the artwork 22. When the resin is cured, it hardens. The nubs 26 also harden and remain attached to the outer surface of the artwork 22. Many artists believe that the nubs 26 present a poor appearance and wish to remove the nubs 26. In many instances, the nubs 26 are removed by sanding off or filing off the nubs. The present patent application is directed to providing and using an artwork substrate having an raised outer edge that prevents the curable material from flowing over the outer perimeter and forming undesirable nubs.

FIG. 5 shows one method for minimizing the presence of nubs 26. Before pouring the resin over the artwork, surfaces of the artwork are covered with masking tape 28. The nubs 26 pool on the masking tape 28. After curing, the masking tape 28 may be peeled away from the artwork to provide the artwork with a clean, nub-free outer surface.

FIG. 6 shows another embodiment in which the masking tape 28′ is more rugged. The masking tape 28′ may be sealing tape, electrical tape, or duck tape. After the resin material cures, the masking tape 28′ may be peeled away from the artwork to provide the artwork with a clean, nub-free outer surface.

FIG. 7 shows an underside of a prior art substrate 50 that is used to make art. The prior art substrate 50 may be made of metal such as aluminum or steel. The prior art substrate has a top surface (not shown) that is covered with a resin coating, which is then cured. As the resin material is applied over the top surface of the substrate 50, the flowable, resin spills over the outer edges 52 of the substrate and forms residue, beads or nubs 54 that overlie the underside 56 of the substrate 50. After the resin is cured, the nubs 54 are hardened and must be removed, such as by sanding or filing the nubs to clean up the underside surface.

In one embodiment, an artwork system preferably includes an artwork substrate having a top surface, a bottom surface, and an outer perimeter. In one embodiment, the outer perimeter of the artwork substrate desirably includes a curved outer edge that projects above the top surface of the artwork substrate to define a raised rim that extends around the outer perimeter of the artwork substrate.

In one embodiment, an artwork, such as a painting or a photograph, is positioned atop the top surface of the artwork substrate. In one embodiment, the painting may be painted directly onto the top surface of the artwork substrate.

In one embodiment, a transparent resin coating overlies the artwork and the top surface of the artwork substrate. In one embodiment, the transparent resin coating has an outer perimeter that abuts against an inner surface of the curved outer edge of the artwork substrate.

In one embodiment, the artwork substrate is made of a metal such as aluminum or an aluminum alloy.

In one embodiment, the top and bottom surfaces of the artwork substrate are anodized.

In one embodiment, the top surface of the artwork substrate is flat.

In one embodiment, the artwork includes a painting overlying the top surface of the artwork substrate.

In one embodiment, the transparent resin coating includes a curable epoxy, an ultraviolet light stabilizer, and a hindered amine light stabilization additive.

In one embodiment, the curved outer edge has an inner surface that defines a concave curved surface an outer surface that defines a convex curved surface.

In one embodiment, the artwork system desirably includes a second artwork overlying a top surface of the first transparent resin coating, and a second transparent resin coating overlying the second artwork and the top surface of the first transparent resin coating. Additional artwork and additional transparent coatings may be placed over the second transparent coating to create art having multiple layers, depth, and/or a 3D-like appearance.

In one embodiment, an artwork system desirably includes a metal substrate having a top surface, a bottom surface, and an outer perimeter. In one embodiment, the top surface of the metal substrate is anodized.

In one embodiment, the outer perimeter of the metal substrate preferably includes a curved outer edge that projects above the top surface of the metal substrate to define a raised rim that extends around the outer perimeter of the metal substrate.

In one embodiment, the top surface of the metal substrate is covered by a painting.

In one embodiment, a curable, transparent, coating desirably overlies the painting and the top surface of the metal substrate. In one embodiment, the curable transparent coating has an outer perimeter that abuts against the curved outer edge of the metal substrate.

In one embodiment, the metal substrate may be made of metals such as aluminum, aluminum alloys, stainless steel, tin, and combinations thereof.

In one embodiment, the curved outer edge preferably has an inner concave surface that faces toward a center of the metal substrate, and an outer convex surface that faces away from the center of the metal substrate.

In one embodiment, the curable, transparent coating preferably has an outer perimeter that abuts against the inner concave surface of the curved outer edge of the metal substrate

In one embodiment, the artwork system may include a second painting overlying a top surface of the first curable, transparent coating, and a second curable, transparent coating overlying the second painting and the top surface of the first curable, transparent coating.

In one embodiment, a method of making an artwork unit preferably includes obtaining a metal substrate having a top surface, a bottom surface and an outer edge that defines an outer perimeter of the metal substrate, and bending the outer edge of the metal substrate to form a curved outer edge at the outer perimeter of the metal substrate. In one embodiment, the curved outer edge projects above the top surface of the metal substrate and has an inner concave surface that faces toward a center of the metal substrate and an outer convexly curved surface that faces away from the center of the metal substrate.

In one embodiment, the method may include anodizing at least the top surface of the metal substrate.

In one embodiment, the method may include placing an artwork over the anodized top surface of the metal substrate, whereby the artwork is bounded by the curved outer edge of the metal substrate, and depositing a curable, transparent coating over the artwork and the anodized top surface of the metal substrate.

In one embodiment, the method may include spreading the curable, transparent coating away from the center of the metal substrate and toward the curved outer edge at the outer perimeter of the metal substrate until an outer perimeter of the curable, transparent coating abuts against the concave inner surface of the curve outer edge.

In one embodiment, the method may include allowing the curable, transparent coating to flow away from the center of the metal substrate and toward the curved outer edge at the outer perimeter of the metal substrate so that an outer perimeter of the curable, transparent coating abuts against the concave inner surface of the curve outer edge.

In one embodiment, the method may include curing the curable, transparent coating to provide a first cured, transparent coating, placing a second artwork over a top surface of the first cured, transparent coating, and depositing a second curable, transparent coating over the second artwork and the top surface of the first curved transparent coating.

In one embodiment, the substrate is preferably placed atop a flat support surface prior to depositing the curable, transparent coating atop the top surface of the substrate.

### BRIEF DESCRIPTION OF THE DRAWINGS

FIG. 1 shows a method of pouring a curable material over artwork.

FIG. 2 shows the curable material of FIG. 1 flowing over an outer edge of the artwork.

FIG. 3 shows another view of the curable material of FIG. 1 flowing over the outer edge of the artwork.

FIG. 4 shows a bottom view of artwork having nubs formed thereon.

FIG. 5 shows a tape having nubs thereon being pulled away from a rear surface of artwork.

FIG. 6 shows a tape having nubs thereon being pulled away from a rear surface of another artwork.

FIG. 7 shows an artwork substrate having nubs formed on a rear surface thereof.

FIG. 8 shows a top perspective view of an artwork substrate having a raised edge, in accordance with one embodiment of the present patent application.

FIG. 9 shows a bottom view of the artwork substrate shown in FIG. 8.

FIG. 10A shows a top plan view of an artwork substrate having a raised edge, in accordance with one embodiment of the present patent application.

FIG. 10B shows a bottom view of the artwork substrate shown in FIG. 10A.

FIG. 100 shows a top perspective view of the artwork substrate shown in FIG. 10A.

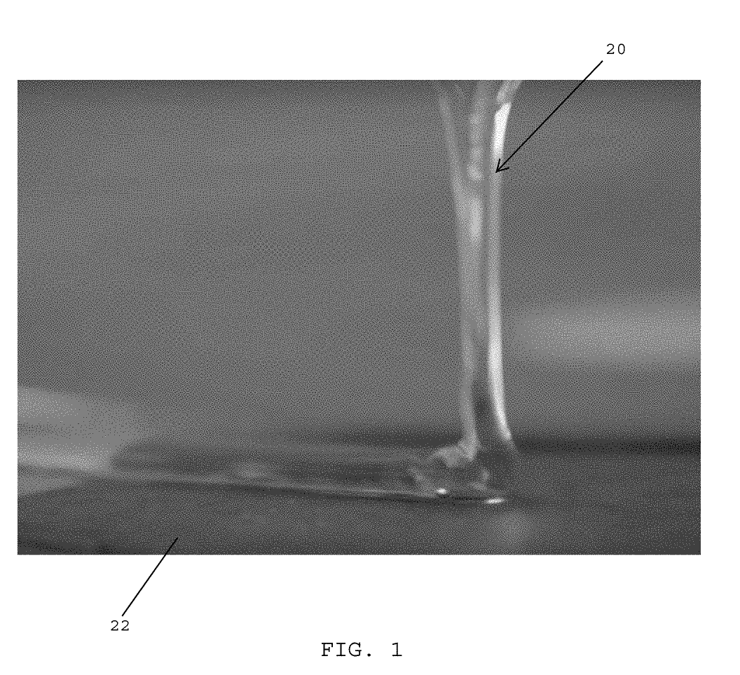

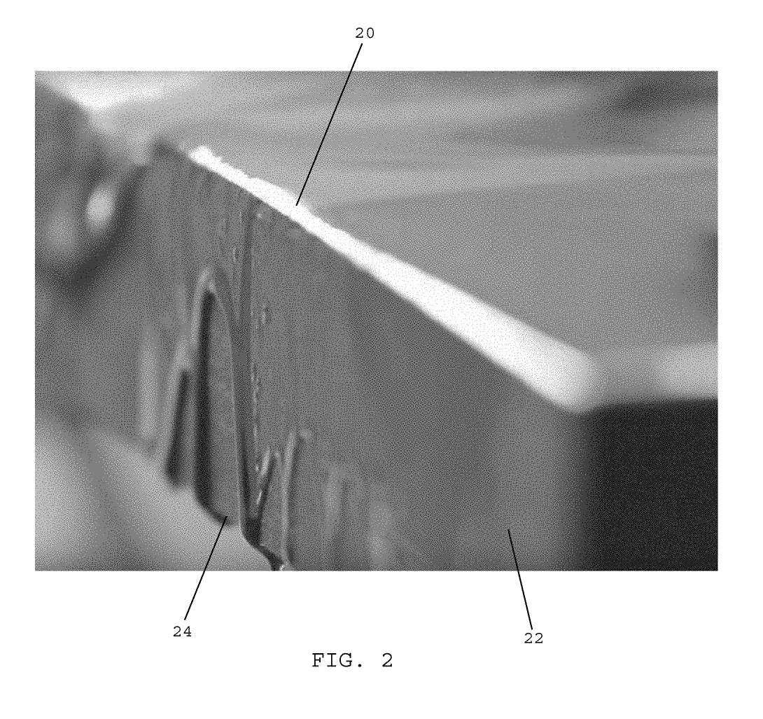

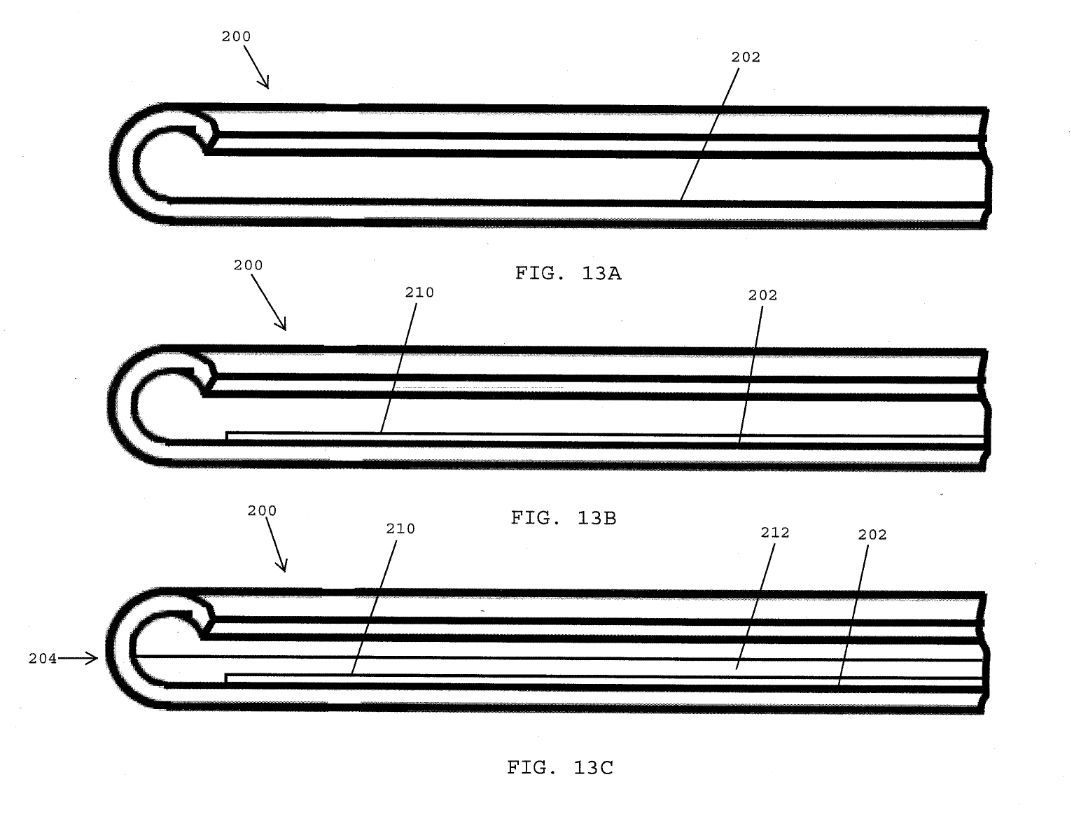

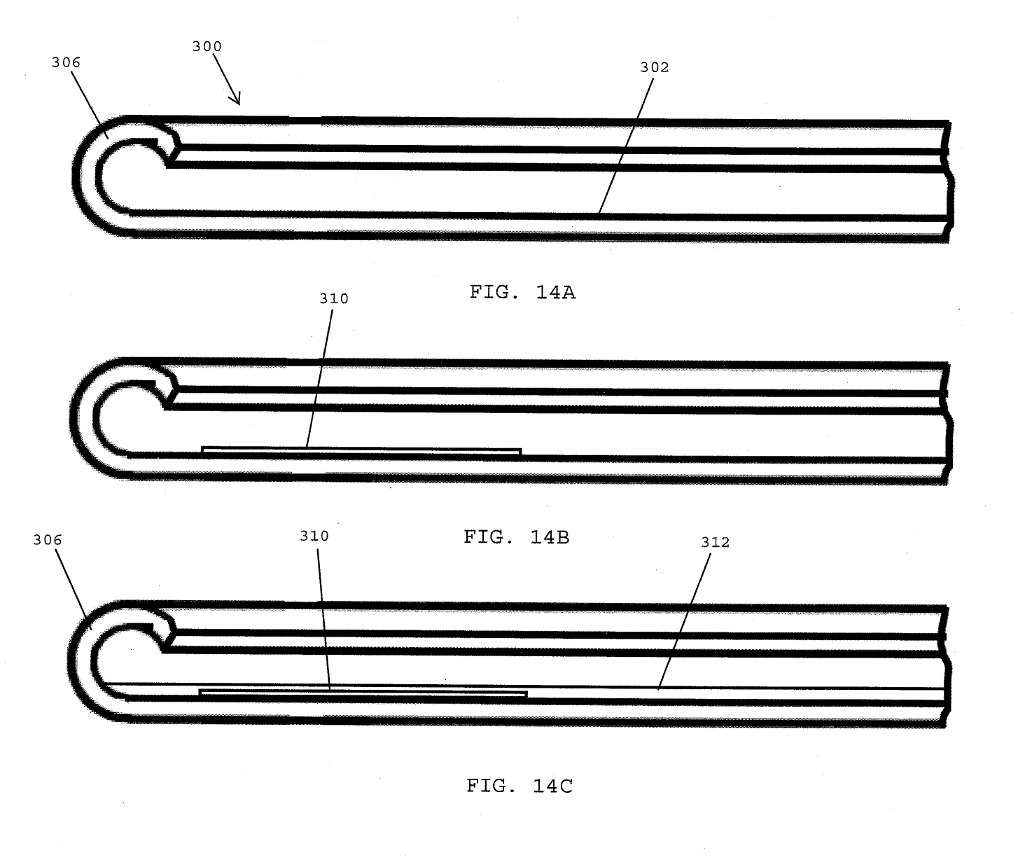

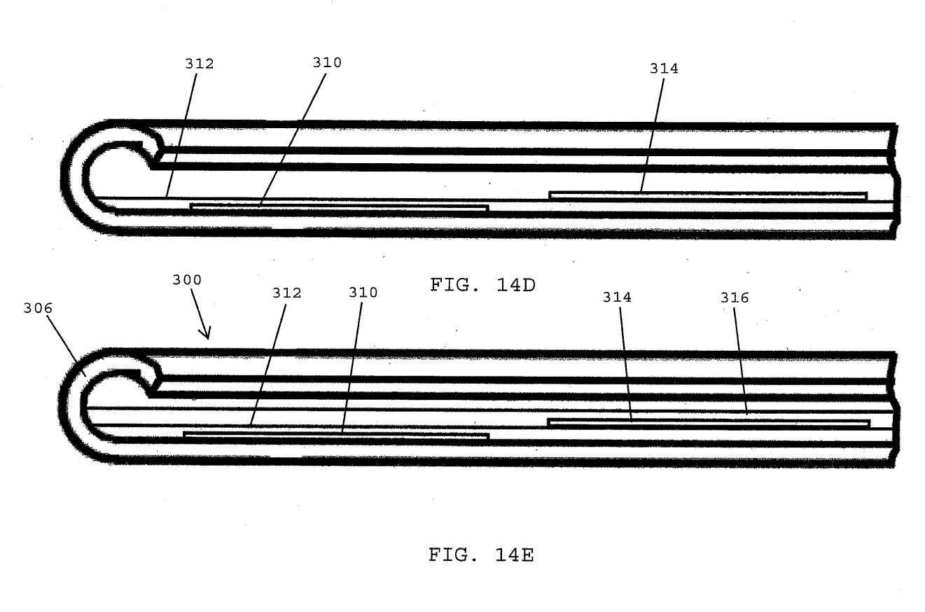

FIG. 11 shows a cross-sectional view of the artwork substrate shown in FIG. 10.

FIG. 12 shows a magnified view of an outer region of the artwork substrate shown in FIGS. 10 and 11.

FIG. 13A shows a first stage of a method of making art on an artwork substrate, in accordance with one embodiment of the present patent application.

FIG. 13B shows a second stage of a method of making art on an artwork substrate, in accordance with one embodiment of the present patent application.

FIG. 13C shows a third stage of a method of making art on an artwork substrate, in accordance with one embodiment of the present patent application.

FIG. 14A shows a first stage of a method of making art on an artwork substrate, in accordance with one embodiment of the present patent application.

FIG. 14B shows a second stage of a method of making art on an artwork substrate, in accordance with one embodiment of the present patent application.

FIG. 14C shows a third stage of a method of making art on an artwork substrate, in accordance with one embodiment of the present patent application.

FIG. 14D shows a fourth stage of a method of making art on an artwork substrate, in accordance with one embodiment of the present patent application.

FIG. 14E shows a fifth stage of a method of making art on an artwork substrate, in accordance with one embodiment of the present patent application.

### DETAILED DESCRIPTION OF PREFERRED EMBODIMENTS

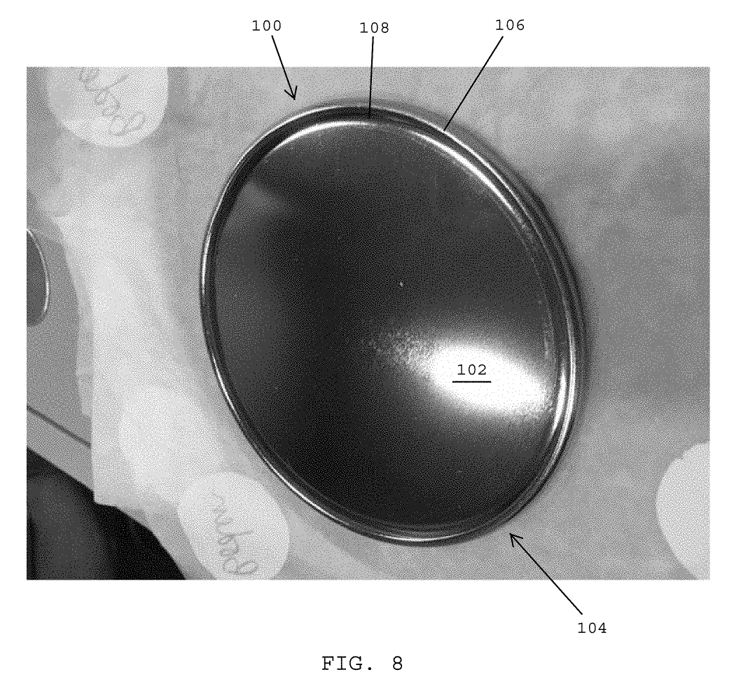

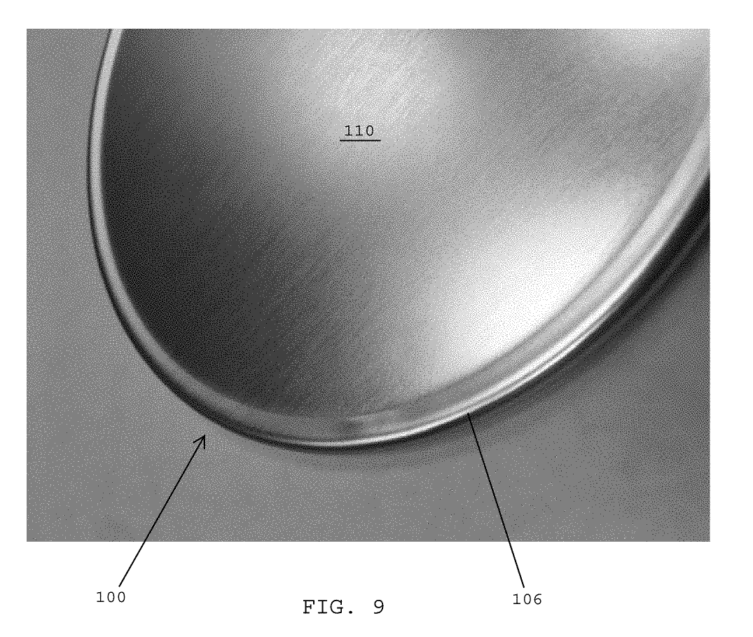

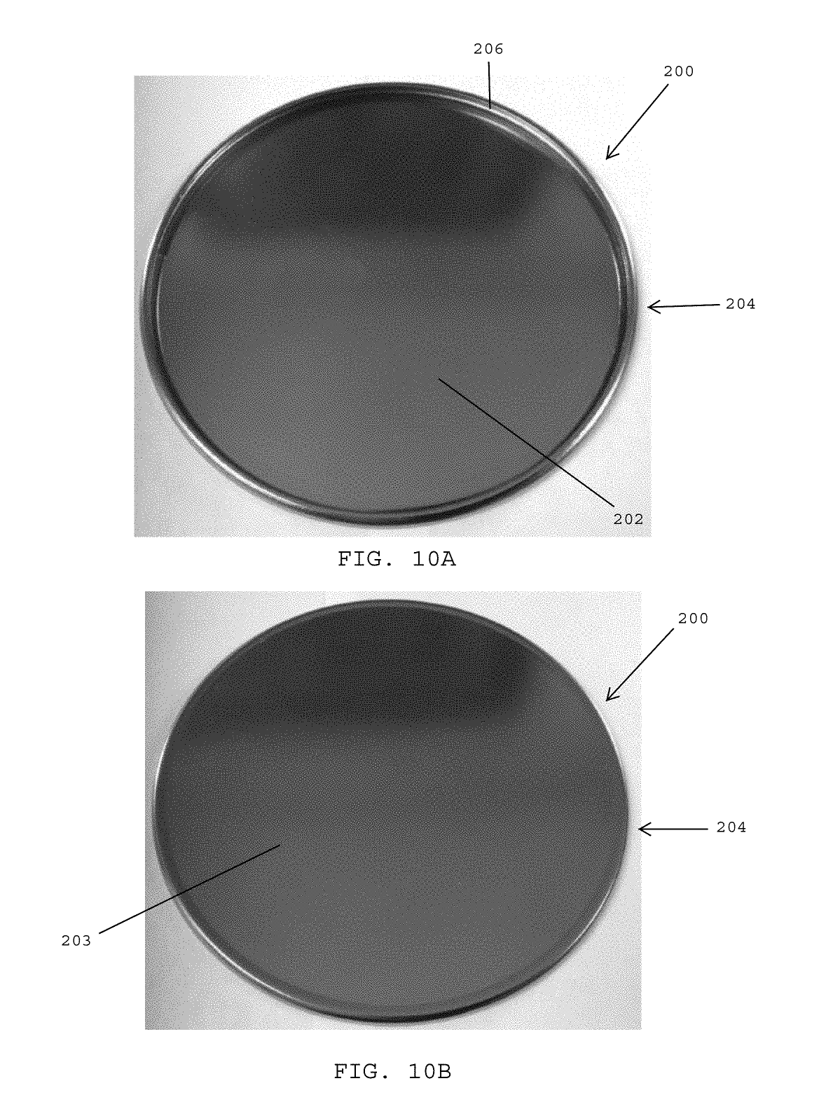

Referring to FIG. 8, in one embodiment, an artwork substrate 100 preferably has a top surface 102 and an outer perimeter 104 having a raised outer edge 106. In one embodiment, the raised outer edge 106 desirably extends above the top surface 102 of the substrate 100 for preventing the poured resin coating from flowing over the outer perimeter 104, which minimizes the likelihood of the resin flowing over the sides of the substrate and forming unwanted nubs on the sides or underside of the substrate. In one embodiment, the artwork substrate 100 has a trough 108 that is located inside the perimeter of the raised outer edge 106. In one embodiment, the trough 108 provides a gutter or gully for collecting the resin adjacent the outer perimeter 104 of the artwork substrate 100. The trough 108 may be a depression located between the outer perimeter of the top surface 102 and the raised outer edge 106.

In one embodiment, the artwork substrate 100 is preferably made of metal such as aluminum, aluminum alloys, tin or steel. In one embodiment, the substrate is made of metal and is anodized prior to receiving the artwork or the clear coatings. In other embodiments, the substrate may be made of other materials including polymers, plastics, cellulose, paper, fiberboard, cardboard, metal, alloys, or combinations of two or more of any of the above-listed materials. In one embodiment, the artwork substrate 100 is preferably shaped so that it includes a top surface, a bottom surface, a raised edge that projects above the top surface, and a trough that is located between the top surface and the raised edge for collecting any resin material that flows beyond the outer perimeter of the top surface.

In one embodiment, the artwork substrate 100 has a circular shape. In other embodiments, the artwork substrate 100 may have other geometric shapes including but not limited to squares, rectangles, polygons, parallelograms, and triangles.

In one embodiment, a picture may be painted onto a surface of the artwork substrate 100 and the painted picture is preferably covered by a curable, resin coating. In one embodiment, the resin coating is cured to provide a clear coat over the painted picture. In one embodiment, the painted surface overlies the top surface 102 of the substrate 100 (FIG. 8). In one embodiment, two or more layers of the curable, resin coating may be applied over the substrate. The curable, resin coating may be the ArtResin product disclosed herein.

In one embodiment, the artwork substrate 100 is preferably made of aluminum and the top surface of the aluminum substrate is painted with a picture. After the picture is painted on the top surface, the resin coating is applied over the top surface of the substrate and the painted picture. The raised rim and the trough preferably prevent the uncured resin material from spilling over the outer perimeter of the substrate 100.

In one embodiment, the artwork substrate has a circular or disc shape and the raised edge is a raised rim that extends around the outer perimeter of the substrate, with a circular trough being located between the outer perimeter of the top surface of the substrate and the raised rim. In one embodiment, the raised edge extends above the top surface of the substrate to form a dam that extends completely around the outer perimeter of the substrate. In one embodiment, the circular trough preferably collects the resin material that flows outside the outer perimeter of the top surface and the raised rim prevents the resin material from spilling over the outer perimeter of the substrate so that nubs cannot form on the sides of the bottom surface of the artwork substrate.

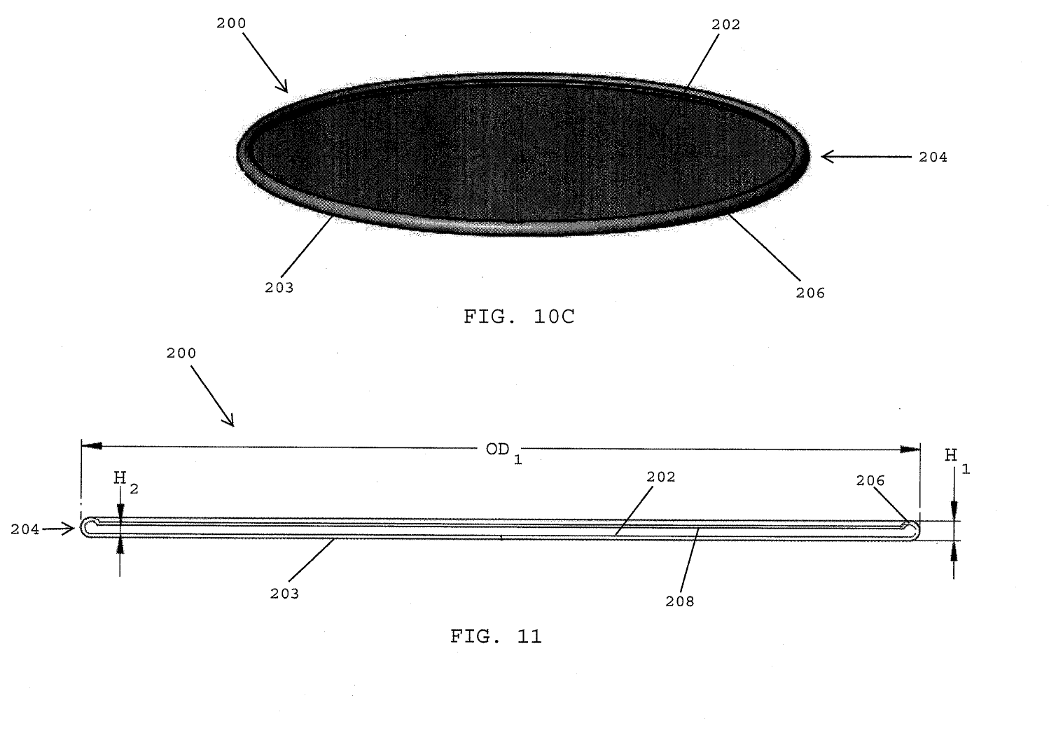

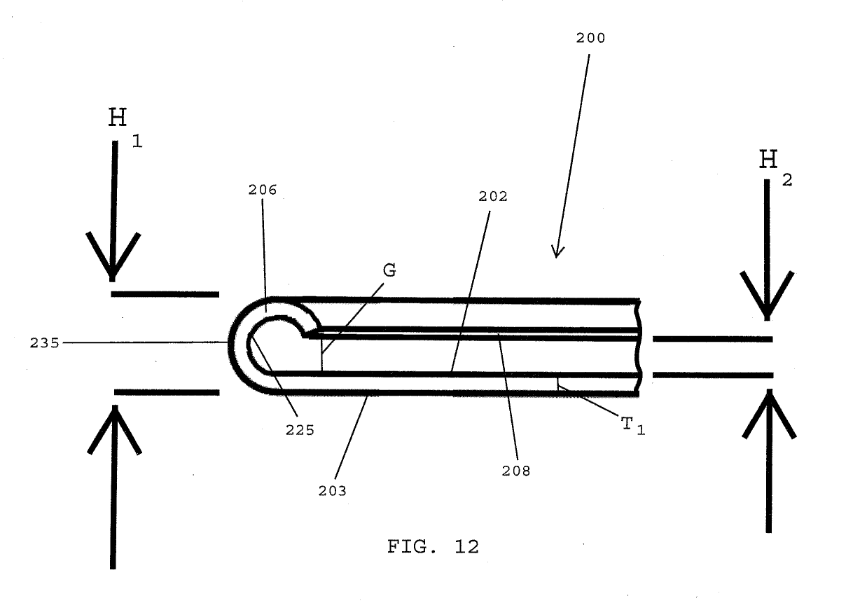

FIG. 9 shows the bottom surface 110 of the artwork substrate 100. The underside of the raised edge 106 extends around the outer perimeter of the bottom surface 110.

In one embodiment, if the resin coating is applied over the top surface of the substrate 100 (FIG. 8), the final product may have the appearance of a coaster with a rim (i.e., the raised edge), whereby any excess resin is collected in the trough.

In one embodiment, if the resin coating is applied over the bottom surface of the substrate 100 (FIG. 9), the final product may be mounted on a wall or surface and may have the appearance of a three dimensional object when viewed from the side.

Referring to FIGS. 10A-10C and 11, in one embodiment, an artwork substrate 200 preferably has a top surface 202, a bottom surface 203, and an outer perimeter 204 that defines as outer circumference of the substrate. In one embodiment, the artwork substrate 200 desirably has a curved outer edge 206 with a free end 208 that projects above the top surface 202 of the substrate 200. In one embodiment, the free end 208 is spaced away from and overlies the top surface 202 of the substrate 200 with a gap G (FIG. 12) being located between the free end 208 of the curved outer edge 206 and the top surface 202 of the substrate 200.

In one embodiment, the curved outer edge 206 may be formed by bending or curving the outer edge using a tool. In one embodiment, the curved outer edge 206 may be formed by spinning the substrate 200 on a lathe and pressing a tool against the free outer end 208 for bending the outer edge into the curved configuration shown in FIGS. 10 and 11. In one embodiment, the curved outer edge 206 preferably extends or projects above the top surface 202 of the substrate 200 to function as a dam or boundary that is located at the outer periphery of the substrate 200. In one embodiment, the curved outer edge 206 desirably prevents a flowable material, such as a curable material (e.g., a clear, curable resin), from flowing over the outer perimeter 204 of the substrate, thereby minimizing the likelihood of the resin flowing over the sides of the substrate and forming undesirable deposits such as unwanted nubs on the underside of the substrate.

Referring to FIGS. 11 and 12, in one embodiment, the artwork substrate 200 desirably has an outer diameter OD₁ of about 5-40 inches, more preferably about 8-20 inches, more preferably about 10-12 inches, and even more preferably about 11.20 inches. In one embodiment, the distance between the top of the curved outer edge 206 and the bottom surface 203 of the artwork substrate 200 preferably defines a height H₁ of about 0.15-0.50 inches, more preferably about 0.25-0.30 inches, and even more preferably about 0.27 inches. In one embodiment, the distance between the free end 208 of the curved outer edge 206 and the top surface 202 of the substrate 200 preferably defines a gap having a height H₂ of about 0.075-0.150 inches, more preferably about 0.10-0.15 inches, and even more preferably about 0.135 inches. Referring to FIG. 12, in one embodiment, the artwork substrate 200 preferably has a thickness T₁ of about 0.040-0.130 inches, more preferably about 0.040-0.080 inches, and even more preferably about 0.050 inches.

Referring to FIG. 12, in one embodiment, the curved outer edge 206 has an inner surface 225 that has a concave curved surface that faces toward a center of the substrate 200 and an outer surface 235 that has a convex surface that faces away from the center of the substrate 200. The curved outer edge 206 preferably projects above the top surface 202 of the artwork substrate 200. The curved outer edge 206 has the free end 208 that preferably overlies the top surface 202 of the artwork substrate. The free end 208 of the curved outer edge 206 is preferably spaced away from the top surface 202 of the artwork substrate 200 to define a gap G between the free end 208 and the top surface 202.

In one embodiment, the artwork substrate 200 is preferably made of metal such as aluminum, aluminum alloys, tin, steel and/or combinations thereof. In one embodiment, an artwork substrate 200 made of metal may have a matte finish, a glossy finish, a semi-glossy finish, or any type of finish between a matte finish and a glossy finish. In other embodiments, the substrate may be made of other materials including polymers, plastics, cellulose, paper, fiberboard, cardboard, metal, alloys, or combinations of two or more of any of the above-listed materials.

The artwork substrate 200 shown in FIGS. 10-12 has a circular or disc-shaped configuration. In other embodiments, however, an artwork substrate may have other geometric shapes including but not limited to squares, rectangles, polygons, parallelograms, and triangles.

Referring to FIG. 13A, in one embodiment, the artwork substrate 200 is made of an aluminum alloy and is prepared for receiving artwork. In one embodiment, the substrate may be dyed prior to receiving artwork. In one embodiment, preparing the aluminum substrate 200 for receiving artwork or for being dyed may include anodizing the substrate 200. In one embodiment, anodizing the substrate enhances the ability of the surfaces of the artwork substrate 200 to retain the artwork or the dyes placed on the surfaces. For example, anodizing the surfaces of the substrate 200 prepares the surfaces for better retaining paint that is brushed, rolled or sprayed onto the surfaces.

Anodizing is an electrochemical process that converts the metal surface of the substrate 200 into a decorative, durable, corrosion-resistant, anodic oxide finish. In one embodiment, aluminum is ideally suited to anodizing, although other nonferrous metals, such as magnesium and titanium, may also be anodized.

The anodic oxide structure originates from the aluminum substrate and is composed entirely of aluminum oxide. This aluminum oxide is not applied to the surface like paint or plating, but is fully integrated with the underlying aluminum substrate, so that it cannot chip or peel. It has a highly ordered, porous structure that allows for secondary processes such as coloring and sealing. See https://www.anodizing.org/page/what_is_anodizing?

In one embodiment, anodizing is accomplished by immersing the aluminum substrate 200 into an acid electrolyte bath and passing an electric current through the medium. A cathode is mounted to the inside of the anodizing tank. The aluminum substrate acts as an anode, so that oxygen ions are released from the electrolyte to combine with the aluminum atoms at the surfaces of the substrate 200. Thus, anodizing involves highly controlled oxidation and enhances a naturally occurring phenomenon.

Referring to FIG. 13B, in one embodiment, after the artwork substrate 200 has been anodized, the substrate 200 is preferably placed atop a flat, level support surface (e.g., a table top). In one embodiment, artwork 210 (e.g., a painting) is desirably placed onto the top surface 202 of the substrate 200. In one embodiment, the artwork 210 is a painting that is painted onto the top surface 202 such as by using a brush, a roller, or a paint sprayer. In one embodiment, the artwork 210 is allowed to dry and cure before any further finishing steps are taken.

In one embodiment, the artwork may be a photograph, an object, a paper, or any other type of art that may be positioned atop a surface of the artwork substrate 200.

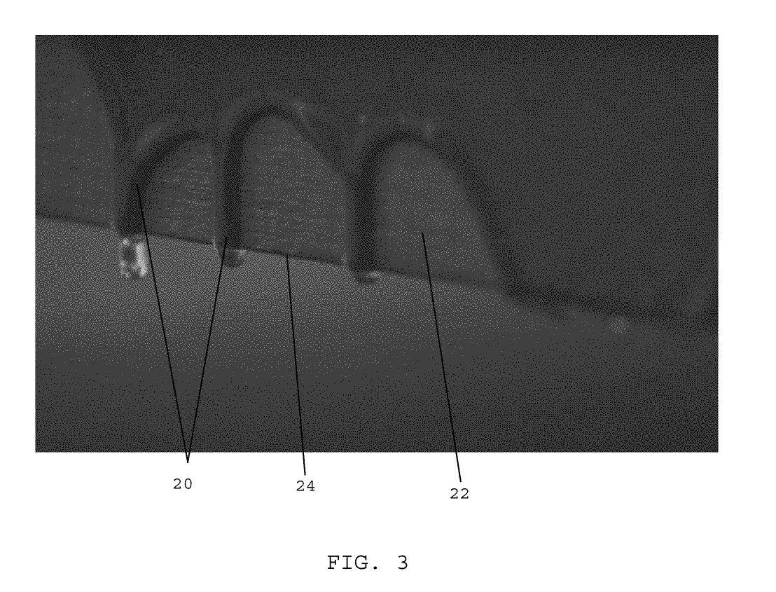

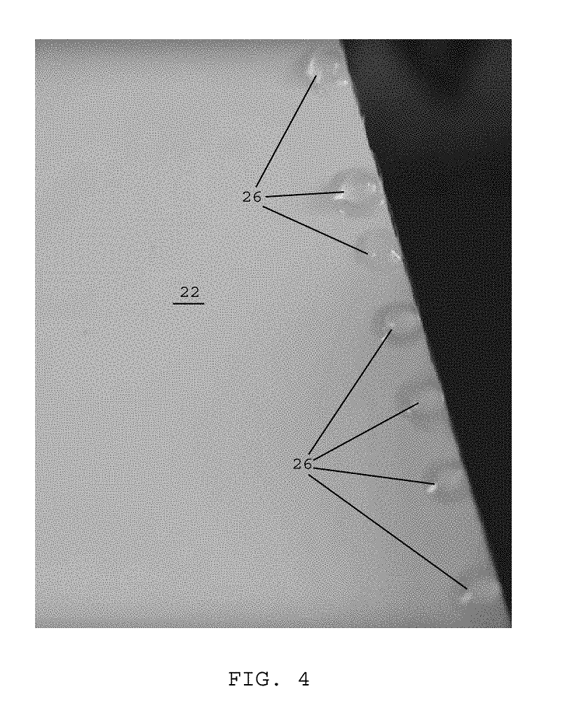

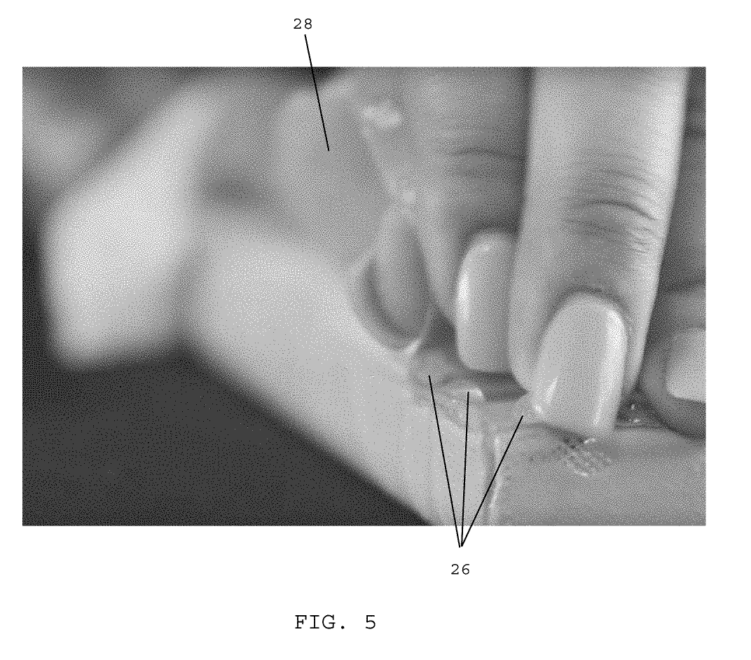

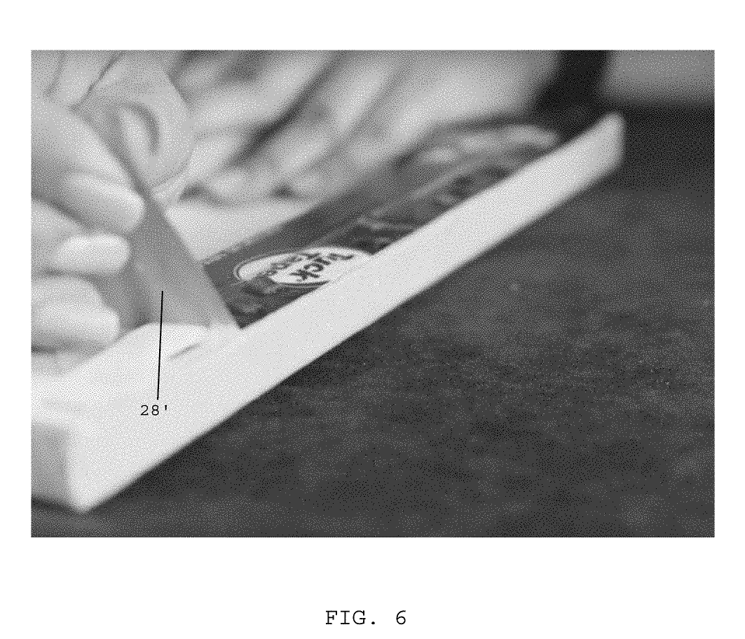

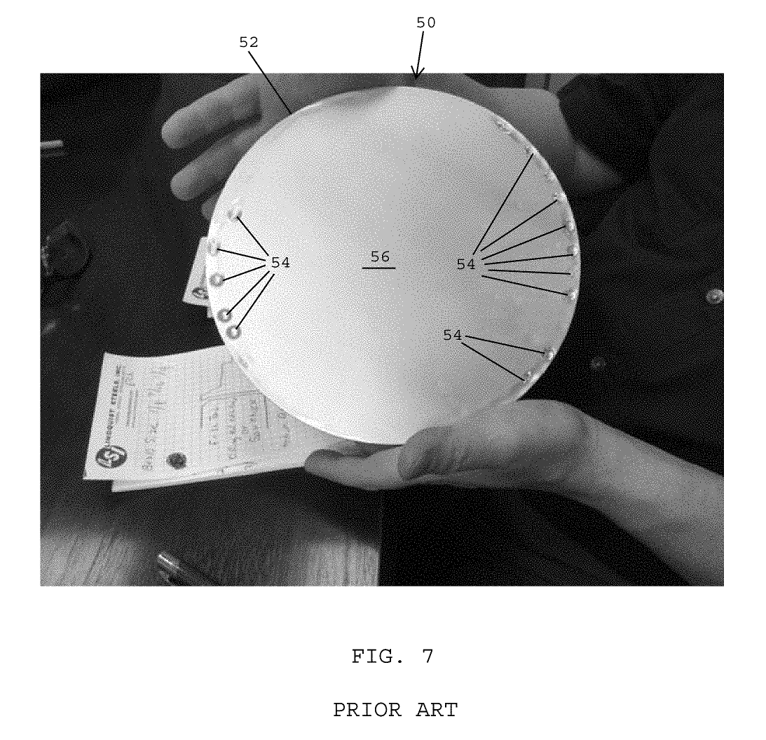

Referring to FIG. 13C, in one embodiment, a curable material 212, such as a transparent, curable epoxy resin (e.g., Art Resin), is preferably applied (e.g., poured) over the artwork 210 and the top surface 202 of the substrate 200. The curable material 212 preferably flows toward the outer perimeter 204 of the substrate 200. The raised, cured outer edge 206 of the substrate 200 desirably acts as a dam or border that prevents the curable material 212 from flowing over the outer perimeter 202 of the substrate, thereby avoiding the overflowing and nub forming problems shown and described above in FIGS. 2-4 and 7.

In one embodiment, because the curable material 212 is flowable, it is self-leveling and forms an even, level coating over the top surface 202 of the substrate 200. In one embodiment, the curable material 212 is allowed to cure to preferably provide a clear, transparent coat over the artwork 210 (e.g., a painted picture) and the top surface 202 of the substrate 200.

In one embodiment, the artwork substrate 200 has a circular or disc shape and the curved outer edge 206 is also circular or disc shaped and extends around the entire outer perimeter 204 of the substrate 200. In one embodiment, the raised, curved outer edge 206 preferably collects the curable material 212 that flows toward the outer perimeter 204 and prevents the curable material from spilling over the outer perimeter 204 of the substrate so that nubs cannot form on the bottom surface or sides of the artwork substrate.

In one embodiment, art having depth and/or a 3D appearance may be formed on an artwork substrate. Referring to FIG. 14A, in one embodiment, an artwork substrate 300 is anodized and placed atop a flat, level support surface (e.g., a table top). Referring to FIG. 14B, in one embodiment, a first artwork 310 is desirably placed onto the top surface 302 of the substrate 300. In one embodiment, the first artwork 310 may be a painting that is painted onto the top surface 302, such as by using a brush, a roller, or a paint sprayer. In one embodiment, the first artwork 310 is allowed to dry and cure before any further finishing steps are taken.

In one embodiment, the first artwork 310 may be a photograph, an object, a paper, or any other type of art that may be positioned atop a surface.

Referring to FIG. 14C, in one embodiment, a first layer of a curable material 312, such as a transparent, curable epoxy resin, is preferably applied (e.g., poured) over the first artwork 310 and the top surface 302 of the artwork substrate 300. The first layer of the curable material 312 preferably flows toward the outer perimeter 304 of the substrate 300. The curved outer edge 306 of the substrate 300 desirably acts as a dam that prevents the first layer of the curable material 312 from flowing over the outer perimeter 304 of the substrate 300, thereby avoiding the overflowing and nub forming problems shown and described above in FIGS. 2-4 and 7.

In one embodiment, because the first layer of the curable material 312 is flowable, it is self-leveling and forms an even, level, first clear coating over the top surface 302 of the substrate 300. In one embodiment, the first layer of the curable material 312 is allowed to cure to preferably provide a first clear coat over the first artwork 310 (e.g., a painted picture).

Referring to FIG. 14D, in one embodiment, after the first layer 312 is cured, a second artwork 314 may be placed onto the exposed, top surface of the cured first layer 312. The second artwork 314 is at a different level than the first artwork 310. After the second artwork 314 is in position, a second layer of a curable material 316, such as a transparent, curable epoxy resin, is preferably applied (e.g., poured) over the second artwork 314 and the top surface of the first cured layer 312. The second layer of the curable material 316 preferably flows toward the outer perimeter 304 of the substrate 300. The curved outer edge 306 of the substrate 300 desirably acts as a dam that prevents the second layer of the curable material 316 from flowing over the outer perimeter 304 of the substrate 300, thereby avoiding the overflowing and nub forming problems shown and described above in FIGS. 2-4 and 7.

In one embodiment, because the second layer of the curable material 316 is flowable, it is self-leveling and forms an even, level, second clear coating that overlies the top surface 302 of the substrate 300, the first artwork 310, the first cured layer 312, and the second artwork 314. In one embodiment, the second layer of the curable material 316 is allowed to cure to preferably provide a second clear coat over the second artwork 314, the first cured layer 312, and the first artwork 310.

After the clear, transparent coatings have cured, the items disclosed herein may be hung on walls or placed atop surfaces to be displayed as artworks. The artwork placed over the surfaces of the substrate are preferably visible through the cured, clear and transparent coatings.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. An artwork system comprising:
an artwork substrate having a top surface, a bottom surface, and an outer perimeter;
the outer perimeter of said artwork substrate including a curved outer edge that projects above said top surface of said artwork substrate to define a raised rim that extends around the outer perimeter of said artwork substrate;
an artwork positioned atop said top surface of said artwork substrate;
a transparent resin coating overlying said artwork and said top surface of said artwork substrate, wherein said transparent resin coating has an outer perimeter that abuts against an inner surface of said curved outer edge of said artwork substrate.

2. The artwork system as claimed in claim 1, wherein said artwork substrate comprises metal.

3. The artwork system as claimed in claim 2, wherein said artwork substrate comprises aluminum or an aluminum alloy.

4. The artwork system as claimed in claim 3, wherein said top and bottom surfaces of said artwork substrate are anodized.

5. The artwork system as claimed in claim 1, wherein said top surface of said artwork substrate is flat.

6. The artwork system as claimed in claim 1, wherein said artwork comprises a painting overlying said top surface of said artwork substrate.

7. The artwork system as claimed in claim 1, wherein said transparent resin coating comprises:
a curable epoxy;
an ultraviolet light stabilizer; and
a hindered amine light stabilization additive.

8. The artwork system as claimed in claim 1, wherein the inner surface of said curved outer edge defines a concave curved surface, and wherein said curved outer edge has an outer surface defining a convex curved surface.

9. The artwork system as claimed in claim 1, further comprising:
a second artwork overlying a top surface of said first transparent resin coating; and
a second transparent resin coating overlying said second artwork and said top surface of said first transparent resin coating.

10. An artwork system comprising:
a metal substrate having a top surface, a bottom surface, and an outer perimeter, wherein said top surface of said metal substrate is anodized;
the outer perimeter of said metal substrate including a curved outer edge that projects above said top surface of said metal substrate to define a raised rim that extends around the outer perimeter of said metal substrate;
said top surface of said metal substrate being covered by a painting;
a curable, transparent, coating overlying said painting and said top surface of said metal substrate, wherein said curable transparent coating has an outer perimeter that abuts against said curved outer edge of said metal substrate.

11. The artwork system as claimed in claim 10, wherein said metal substrate comprises metals selected from the group consisting of aluminum, aluminum alloys, stainless steel, and tin.

12. The artwork system as claimed in claim 10, wherein said curved outer edge comprises:
an inner concave surface that faces toward a center of said metal substrate; and
an outer convex surface that faces away from the center of said metal substrate.

13. The artwork system as claimed in claim 12, wherein said curable, transparent coating has an outer perimeter that abuts against said inner concave surface of said curved outer edge of said metal substrate

14. The artwork system as claimed in claim 10, wherein said top surface of said metal substrate is flat.

15. The artwork system as claimed in claim 10, wherein said curable, transparent coating comprises:
a curable epoxy;
an ultraviolet light stabilizer; and
a hindered amine light stabilization additive.

16. The artwork system as claimed in claim 10, further comprising:
a second painting overlying a top surface of said first curable, transparent coating; and
a second curable, transparent coating overlying said second painting and said top surface of said first curable, transparent coating.

17. A method of making an artwork unit comprising:
obtaining a metal substrate having a top surface, a bottom surface and an outer edge that defines an outer perimeter of said metal substrate;
bending said outer edge of said metal substrate to form a curved outer edge at the outer perimeter of said metal substrate, wherein said curved outer edge projects above said top surface of said metal substrate and has an inner concave surface that faces toward a center of said metal substrate and an outer convexly curved surface that faces away from the center of said metal substrate;
anodizing at least said top surface of said metal substrate;
placing an artwork over said anodized top surface of said metal substrate, wherein said artwork is bounded by said curved outer edge of said metal substrate;
depositing a curable, transparent coating over said artwork and said anodized top surface of said metal substrate.

18. The method as claimed in claim 17, further comprising spreading said curable, transparent coating away from the center of said metal substrate and toward said curved outer edge at the outer perimeter of said metal substrate until an outer perimeter of said curable, transparent coating abuts against said concave inner surface of said curve outer edge.

19. The method as claimed in claim 17, further comprising allowing said curable, transparent coating to flow away from the center of said metal substrate and toward said curved outer edge at the outer perimeter of said metal substrate so that an outer perimeter of said curable, transparent coating abuts against said concave inner surface of said curve outer edge.

20. The method as claimed in claim 17, further comprising:
curing said curable, transparent coating to provide a first cured, transparent coating ;
placing a second artwork over a top surface of said first cured, transparent coating;
depositing a second curable, transparent coating over said second artwork and said top surface of said first curved transparent coating.
